(19) United States
(12) Patent Application Publication
(10) Pub. No.: US 2010/0188339 A1
(43) Pub. Date: Jul. 29, 2010

(54) Light-emitting device for keyboard

(76) Inventors: Shih-Kun Yeh, Luchu Hsiang (TW); Chun-Tai Lee, Luchu Hsiang (TW)

Correspondence Address: Jackson Intellectual Property Group PLLC, 106 Starvale Lane, Shipman, VA, 22971, US

(21) Appl. No.: 12/071,160

(22) Filed: Feb. 15, 2008

(51) Int. Cl. G06F 3/02

(52) U.S. Cl. 345/170

(57) ABSTRACT

The light-emitting device of the creation comprises a light guide plate and at least one flexible carrier plates disposed below the light guide plate; wherein each of said flexible carrier plate has a supporting portion equipped with a plurality of light emitting diodes (LEDs), and a wire for electrically connecting each of the LEDs and the control terminal of the keyboard in order to obtain a light-emitting device for a keyboard, in which the material costs can be significantly lowered and the LEDs or circuits can be renewed or replaced as long as the flexible carrier plates for loading said LEDs are replaced.

### BACKGROUND OF THE INVENTION

(a) Field of the Invention

The creation relates to alight-emitting device improvement for a keyboard, and aims to provide a light-emitting device for a keyboard, in which the material costs can be significantly lowered and the light emitting diodes (LEDs) or circuits can be renewed or replaced as long as the flexible carrier plates for loading said LEDs are replaced.

(b) Description of the Prior Art

It is learned that blue light computer keyboards became popular since 2005. Light-emitting devices with light emitting diodes (LEDs) are built in keyboards, such that players can view the position of keys clearly in a dark environment and the attraction of such keyboards would be increased. Whereupon, the function of enhancing the game's effects can also be achieved, such keyboards can be applied to business computers for presentation, various engineering computers and military computers for operation in a low-light level, even a lightless environment.

FIG. 1 depicts a structure of a general keyboard with a light emitting function. As a light-emitting device of the prior art for the keyboard, a light guide plate 20 and a flexible printed circuit board 30 equipped with a plurality of light emitting diodes (LEDs) 40 are in turn disposed correspondingly below the keys 10 of the keyboard, that is, the entire light-emitting device is the single flexible circuit board 30 used as a construct for loading all the light emitting diodes (LEDs) 40 and for electrically connecting all the light emitting diodes (LEDs) 40 and the control terminal of the keyboard.

However, for the purpose of satisfying the convenience of actual operation, the keys 10 of a general keyboard are disposed over a wide range and therearound provided with some equipment like a power button, a mouse pad, speakers, warning lamps, and so forth. As a result, the entire area of a single flexible printed circuit board 30 must cover the range of the peripheral equipment of the keys 10 to electrically and reliably connect said equipment. This can result in extremely high material costs. Meanwhile, when the light emitting diodes (LEDs) 40 or circuits on the flexible circuit board break down, it is impossible to simply replace the faulted parts of the whole. All of the flexible printed circuit board 30 together with the light emitting diodes (LEDs) 40 needs to be replaced. Therefore, the costs of maintenance and production are relatively high while today's environmental demands cannot be met.

### SUMMARY OF THE INVENTION

In view of the above-mentioned problems, the creation has been made to improve a light-emitting device for a luminous keyboard and has an object to provide a light-emitting device for a keyboard, in which the material costs can be significantly lowered and the light emitting diodes (LEDs) or circuits can be renewed or replaced as long as the flexible carrier plates for loading said LEDs are replaced.

To achieve the foregoing objectives, the entire light-emitting device mainly comprises a light guide plate and at least one flexible carrier plates disposed below the light guide plate; wherein each of said flexible carrier plate has a supporting portion equipped with a plurality of light emitting diodes (LEDs), and a wire for electrically connecting each of the light emitting diodes (LEDs) and the control terminal of the keyboard. Thus, the area of a single flexible carrier plate can be effectively reduced and the material costs can be significantly lowered. In particular, when the light emitting diodes (LEDs) or circuits break down, they can be renewed or replaced as long as the flexible carrier plates for loading said LEDs are replaced.

Specifically, the light-emitting device for a keyboard according to the creation has the following effects:

1. The area of a single flexible carrier plate can be effectively reduced and the undesired connecting regions between the flexible carrier plates can also be saved, thereby significantly lowering the material costs.

2. The light emitting diodes (LEDs) or circuits can be renewed or replaced as long as the flexible carrier plates for loading said LEDs are replaced instead of replacing all of the flexible carrier plates together with the light emitting diodes (LEDs). The costs of maintenance and production can be reduced while still meeting today's environmental demands.

### BRIEF DESCRIPTION OF THE DRAWINGS

FIG. 1 is an exploded view showing a structure of a light-emitting device of the prior art for a keyboard.

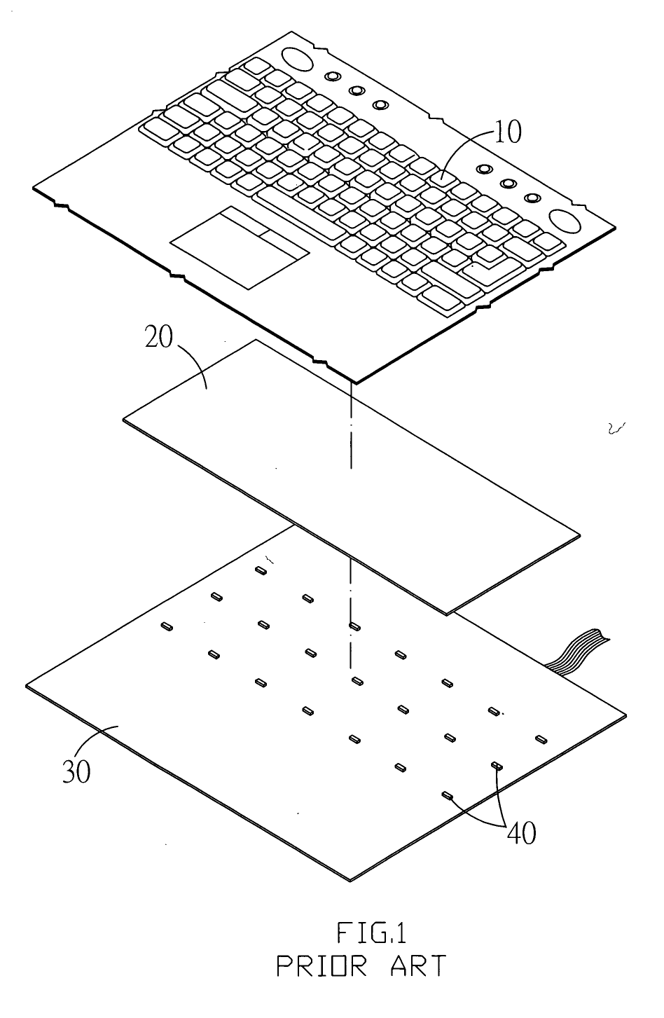

FIG. 2 is an exploded view showing a structure of a light-emitting device according to a first embodiment of the creation.

FIG. 3 is an exploded view showing a structure of a light-emitting device according to a second embodiment of the creation.

FIG. 4 is a structural drawing showing an appearance of a flexible carrier plate according to a second embodiment of the creation.

### DETAILED DESCRIPTION OF THE PREFERRED EMBODIMENTS

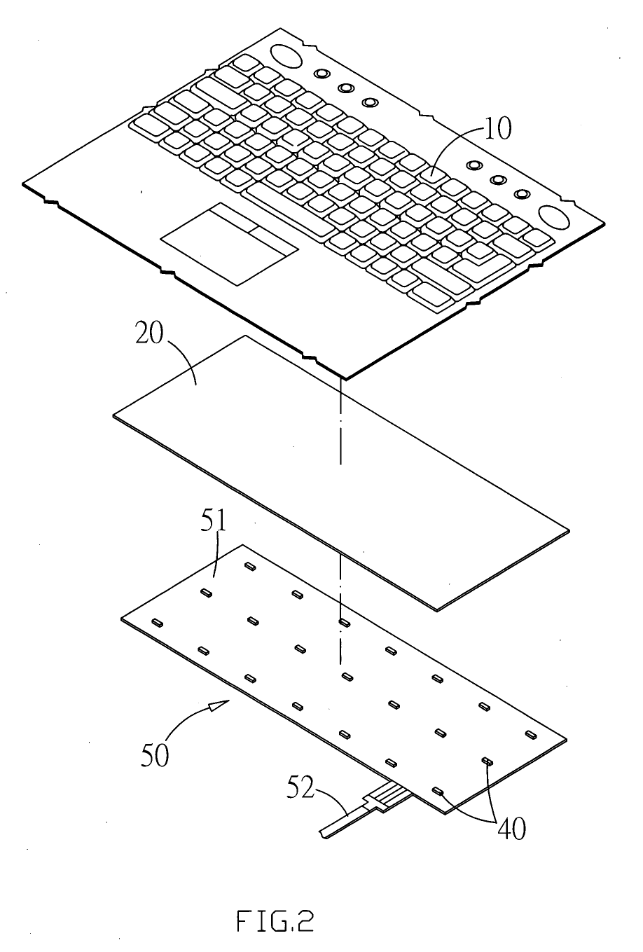

As illustrated in FIG. 2, a light-emitting device for a keyboard according to the creation mainly comprises at least one optical film (in this embodiment, the optical film is a light guide plate 20) and at least one flexible carrier plates 50.

Wherein the light guide plate 20 is correspondingly disposed below the keys 10 of the keyboard; the flexible carrier plate 50 is disposed at a specific position below the light guide plate 20, and said flexible carrier plate 50 has a supporting portion 51 equipped with a plurality of light emitting diodes (LEDs) 40, and a wire 52 for electrically connecting each of the light emitting diodes (LEDs) 40 and the control terminal of the keyboard (not shown). The wire 52 can be a flexible flat cable (FFC), a coaxial line, or an electronic wire, or the like.

Accordingly, all the light emitting diodes (LEDs) 40 in the entire light-emitting device are correspondingly arranged below the keys 10 through the flexible carrier plate 50. When the light emitting diodes (LEDs) 40 emit light, it will be diffused by the light guide plate 20 to obtain the entire luminescence of the region of the keys 10 of the keyboard.

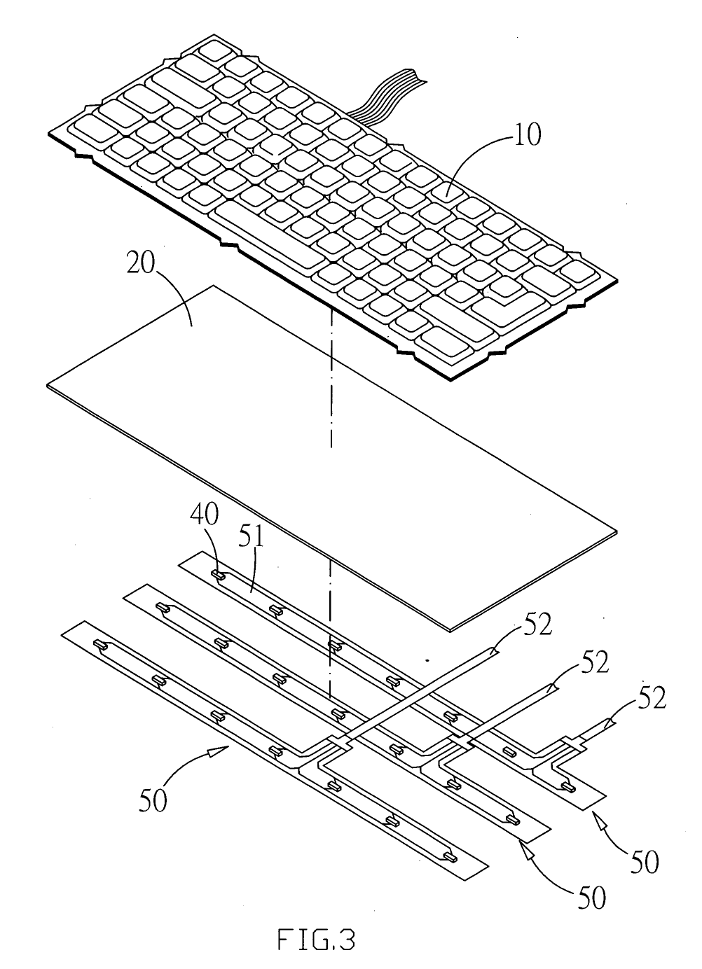

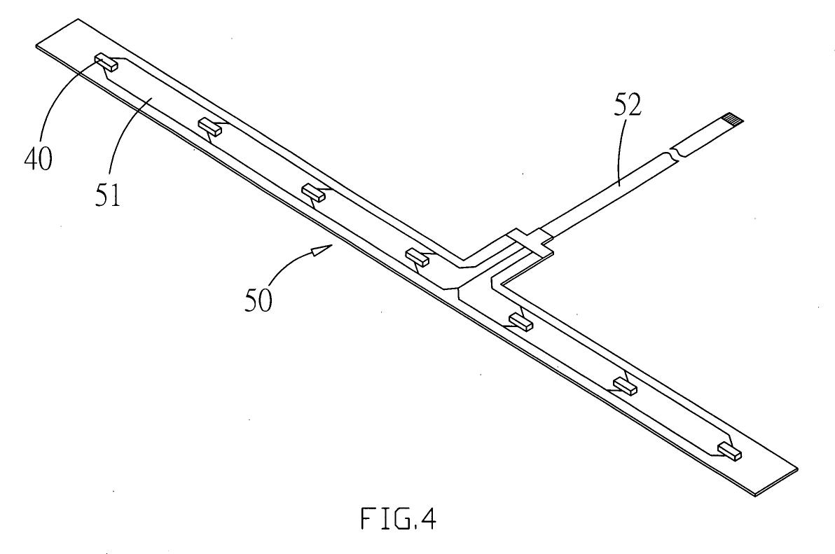

Furthermore, as illustrated in FIGS. 3 and 4, another light-emitting device for a keyboard according to the creation comprises at least one optical film (in this embodiment, the optical film is a light guide plate 20) and a plurality of flexible carrier plates 50, wherein the light guide plate 20 is correspondingly disposed below the keys 10 of the keyboard; each of said flexible carrier plates 50 is disposed at a specific position below the light guide plate 20, and each of said flexible carrier plates 50 has a supporting portion 51 equipped with a plurality of light emitting diodes (LEDs) 40, and a wire 52 for electrically connecting each of the light emitting diodes (LEDs) 40 and the control terminal of the keyboard (not shown). The wire 52 can be a flexible flat cable (FFC), a coaxial line, or an electronic wire, or the like.

Accordingly, all the light emitting diodes (LEDs) 40 in the entire light-emitting device are correspondingly arranged below the keys 10 through each of the flexible carrier plates 50. When the light emitting diodes (LEDs) 40 emit light, it will be diffused by the light guide plate 20 to obtain the entire luminescence of the region of the keys 10 of the keyboard.

It should be noted that in this embodiment, the arrangement of all the light emitting diodes (LEDs) is achieved by the plurality of flexible carrier plates disposed at the specific position. Therefore, the light emitting diodes with different luminous effects can be arranged with respect to the keys 10 located at the different locations, thereby enhancing the variability of the entire light-emitting device.

Above all, the area of the flexible carrier plates can be effectively reduced and the undesired connecting regions between the flexible carrier plates can also be saved, thereby significantly lowering the material costs. It is more obvious when the flexible carrier plates are made of flexible printed circuit boards. Moreover, the light emitting diodes (LEDs) or circuits can be renewed or replaced as long as the flexible carrier plates for loading said LEDs are replaced instead of replacing all of the flexible carrier plates together with the light emitting diodes (LEDs). The costs of maintenance and production can be reduced while still meeting today's environmental demands.

In view of the aforementioned, the creation provides an improved light-emitting device for a keyboard, and the application for a patent is duly filed accordingly. The technical contents and features of the creation are disclosed above. However, anyone familiar with the technique could possibly make modify or change the details in accordance with the creation without departing from the technologic ideas and spirit of the creation. The protection scope of the creation shall not be limited to what embodiment discloses, and should include various modification and changes that are made without departing from the technologic ideas and spirit of the creation, and should be covered by the claims mentioned below.

I claim:

1. A light-emitting device for a keyboard comprising:
a plurality of keys;
at least one flexible carrier plates, each of which is a flexible printed circuit board and disposed at a specific position below the keys, wherein each of said flexible carrier plate has a supporting portion equipped with a plurality of light emitting diodes (LEDs), and a wire for electrically connecting each of the light emitting diodes (LEDs) and the control terminal of the keyboard; and
at least one optical film, which is correspondingly disposed below the keys of the keyboard.

2. The light-emitting device for a keyboard according to claim 1, wherein the optical film is a light guide plate.

3. The light-emitting device for a keyboard according to claim 1, wherein the light emitting diodes (LEDs) with different luminous effects are arranged on each of said flexible carrier plate with respect to the keys located at the different locations.

4. The light-emitting device for a keyboard according to claim 1, wherein the wire electrically connected to the control terminal of the keyboard is a flexible flat cable (FFC).

5. The light-emitting device for a keyboard according to claim 1, wherein the wire electrically connected to the control terminal of the keyboard is a coaxial line.

6. The light-emitting device for a keyboard according to claim 1, wherein the wire electrically connected to the control terminal of the keyboard is an electronic wire.

7. A light-emitting device for a keyboard comprising:
a plurality of keys;
a plurality of flexible carrier plates, each of which is a flexible printed circuit board and respectively disposed at a specific position below the keys, wherein each of said flexible carrier plate has a supporting portion equipped with a plurality of light emitting diodes (LEDs), and a wire for electrically connecting each of the light emitting diodes (LEDs) and the control terminal of the keyboard; and
at least one optical film, which is correspondingly disposed below the keys of the keyboard.

8. The light-emitting device for a keyboard according to claim 7, wherein the optical film is a light guide plate.

9. The light-emitting device for a keyboard according to claim 7, wherein the light emitting diodes (LEDs) with different luminous effects are arranged on each of said flexible carrier plate with respect to the keys located at the different locations.

10. The light-emitting device for a keyboard according to claim 7, wherein the wire electrically connected to the control terminal of the keyboard is a flexible flat cable (FFC).

11. The light-emitting device for a keyboard according to claim 7, wherein the wire electrically connected to the control terminal of the keyboard is a coaxial line.

12. The light-emitting device for a keyboard according to claim 7, wherein the wire electrically connected to the control terminal of the keyboard is an electronic wire.
